(19) United States
(12) Patent Application Publication
(10) Pub. No.: US 2004/0243516 A1
(43) Pub. Date: Dec. 2, 2004

(54) Export license determination system

(76) Inventors: Gabriele Zinssmeister, Tuebingen (DE); Andreas Dittrich, Schoenbuch (DE); Martin Trostel, Philosophenweg (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/490,200

(22) PCT Filed: Oct. 1, 2001
(86) PCT No.: PCT/US01/30746

(51) Int. Cl. G06F 17/60

(52) U.S. Cl. 705/59

(57) ABSTRACT

A system includes a server for receiving license determination requests and providing export license determinations in response to the requests. Other aspects and advantages of the present invention will become apparent from the following detailed description, taken in conjunction with the accompanying drawings, illustrating by way of example the principles of the present invention.

### BACKGROUND OF THE INVENTION

Many countries issue regulations on international trade. For instance, the United States issues Export Administration Regulations (EAR) relating to the control of certain exports, re-exports, and activities. The export-control provisions of the EAR are intended to serve national security, foreign policy, nonproliferation, and short supply interests of the United States and, in some cases, to carry out its international obligations. Some controls are designed to restrict access to dual use items by countries or persons that might apply such items to uses inimical to U.S. interests. These include controls designed to stem the proliferation of weapons of mass destruction and controls de-signed to limit the military and terrorism support capability of certain countries. The effectiveness of many of the controls under the EAR is enhanced by their being maintained as part of multilateral control arrangements. Multilateral export control cooperation is sought through arrangements such as the Nuclear Suppliers Group, the Australia Group, and the Missile Technology Control Regime. The EAR also include some export controls to protect the United States from the adverse impact of the unrestricted export of commodities in short supply.

The EAR may require a license to a country if a product is listed on the Commerce Control List (CCL) and if a Country Chart (specified in the EAR) indicates that a license is required to that country. Virtually all Export Con-trol Classification Numbers (ECCN) on the CCL are covered by the Country Chart. These ECCNs state the specific countries that require a license.

Large companies usually maintain staffs of administrators to ensure compliance with export control laws. Before a product can be exported, an administrator must determine whether an export license is needed, whether one is already in place, whether additional assurances are needed, whether the export is prohibited, etc. Maling this determination is slow and manually intensive, especially for a company that sells a large number and variety of products to many different countries. Not only does this determination involve U.S. laws, but it usually involves local exporting country laws as well.

### SUMMARY OF THE INVENTION

A system includes a server for receiving license determination requests and providing export license determinations in response to the requests. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of an export license determination server.

FIG. 2 is an illustration of events and corresponding responses by the server.

FIG. 3 is an illustration of an exemplary license determination table for the server.

### DETAILED DESCRIPTION OF THE PREFERRED EMBODIMENTS

As shown in the drawings for the purpose of illustration, the present invention is embodied in a server for making export license determinations. The server receives information about a pending transaction and determines the transaction is covered by an existing license, whether an export license is needed, or whether other manual work is needed for the transactions. The export license determination is computerized; therefore, the amount of work (especially redundant work) for export administration personnel is mimmized. The server can be on-line 24 hours a day, seven days a week; therefore, export license determinations can be made at any time. The server may offer broad connectivity to multiple client platforms by a web-based, standard interface. The server may include an engine that is table-driven. Making the engine table-driven reduces the amount of hard-coded logic, and simplifies maintenance of the data used for making export license determinations. Tables used by the engine may be centralized. Centralized tables should lead to license determinations that are consistent.

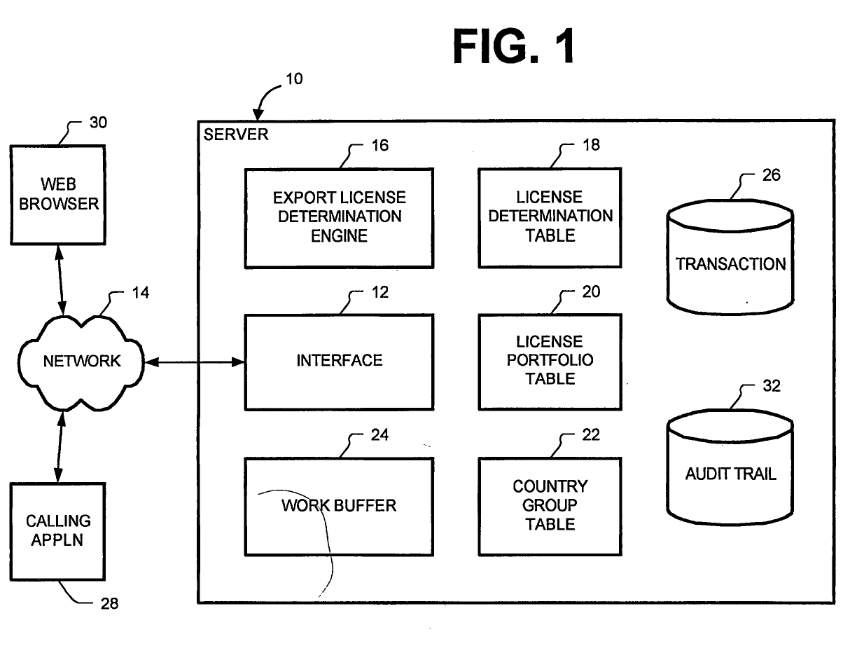

Reference is made to FIG. 1, which illustrates an export license determination server 10. The server 10 includes a network interface 12 that is connected to a network 14. There is no limitation as to the type of network 14. For example, the network 14 can be a corporate intranet or the Internet.

The server 10 provides an export license determination engine 16, a license determination table 18, a license portfolio table 20, and a country group table 22. The network interface 12 receives information about pending transactions via the network 14, and passes the information to the engine 16. The engine 16 uses the tables 18, 20 and 22 to make an export license determination with respect to the transaction.

The pending transaction might be the sale of a product to a destination country. The transaction information may include a destination country. The server 10 uses the country group table 22 to determine a country group for the destination country. A country group may include one or more countries.

The transaction information may also include either a product classification group or a product identifier (which allows the classification group to be ascertained). The classification group may be supplied directly to the server 10. In the alternative the server 10 may send a product identifier to another program, which ascertains the classification group. One such program is disclosed in U.S. Serial No. ______ filed concurrently herewith (Attorney Docket No. 10012302-1). A classification group may be an ECCN or any other designation.

The license determination table 18 includes a series of cells. Each cell indicates a license determination for a particular country group and classification group. A license determination might indicate that a license is not needed, a license is needed but is already in place, manual work is needed (e.g., a license is needed and must be executed, additional assurances are needed to comply with controlling export laws), a transaction is not allowed, etc.

If the license determination indicates that no manual work is needed (that is, the transaction complies with all export regulations), details of the transaction may be stored in a transaction data database 26. If the license determination indicates that further work is needed, details of the transaction may be stored in a work buffer 24. The transaction may remain in the work buffer 24 until another event occurs. As a first example, the transaction may remain in the work buffer 24 until additional manual work brings the transaction into compliance with all export regulations (e.g., an export license is executed). Once the transaction is brought into compliance, it is moved from the work buffer 24 to the transaction data database 26. As a second example, the transaction is deleted from the work buffer 24 if the transaction is cancelled.

The license determination table 18 may be generated by a select group of export administration personnel, and it may be stored in a central location, so that only one table is used by the export license determination engine 16. Centralized decision-making should lead to consistent determinations. Because the export license determination engine 16 is table-driven, the license determinations may be updated (e.g., due to changes in laws, addition of new licenses, lapsing of old licenses) without rewriting the engine 16 or the interface 12.

The license portfolio table 20 stores electronic versions of export licenses that are referenced by the license determination table 18.

There may be one or more license determination tables 18, and there may be one or more license portfolio tables 20. There may be different tables 18 and 20 for different exporting countries.

The server 10 may be implemented in any number of ways. For example, the server 10 may be a part of a larger enterprise system, which includes network-attached storage (NAS) devices or other storage machines. The license determination table 18, the license portfolio table 20 and the country group table 22 (as well as the work buffer 24, the transaction data database 26 and an audit trail database 32 mentioned below) may be stored in the NAS devices or the other storage machines. The server 10 may be a single computer or it may be run as a distributed logic/data system having several computers.

Other transaction information supplied to the server 10 might include ship-to-address, ship-from-address, contract party, and deliver-to-address. This information may be used for audit and legal reporting purposes. This information also facilitates manual follow-ups whenever necessary (as in the case of individual validated licenses).

The transaction information may be supplied by any client 28, 30 that can connect to the server 10. The clients may be personal computers and workstations that are connected to the server 10 via the network 14. Certain clients could include calling applications 28 (e.g., other software applications that make requests for license determinations). In the alternative, calling applications may be integrated with the server 10.

Clients could include web browsers 30 that allow individuals to request license determinations. For example, the interface 12 may include XML files that are downloaded and displayed by the web browsers 30. The XML files would allow the web browsers 30 to enter the transaction information. The web browsers 30 may also display the license determinations and licenses stored in the license portfolio table 20.

The web browser 30 also allows export administration personnel to access the server 10. Certain export administration personnel may be authorized to update the tables 18-22. Others personnel may be authorized to check their portion of the work buffer 24 to determine which transactions need manual attention.

The server 10 may perform functions other than making license determinations. When a transaction is shipped, details of the transaction may be moved from the transaction date database 26 to the audit trail database 32.

The server 10 offers broad connectivity to multiple client platforms by web-based, standard interface. If the server 10 is on-line 24 hours a day, license determinations and related services may be requested at any time.

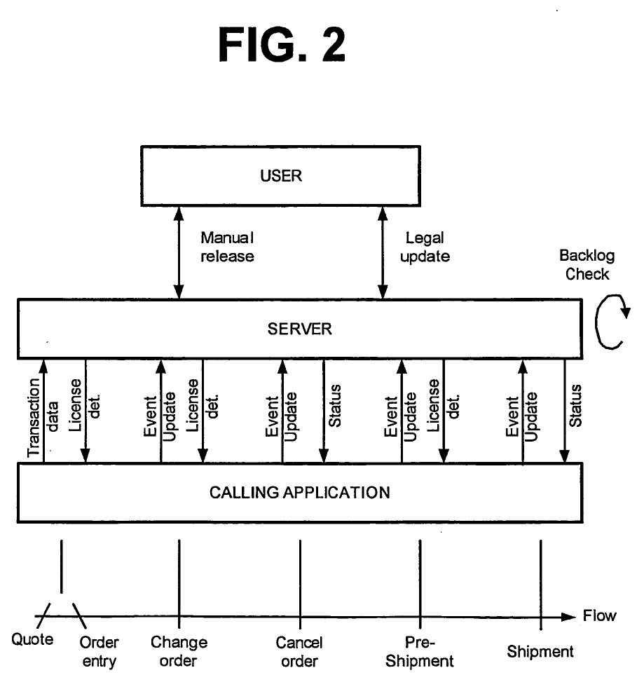

FIG. 2 shows a number of events, and actions taken by the server 10 in response to the events. The events include (1) quote, (2) order entry, (3) change order, (4) cancel order, (5) pre-shipment, (6) shipment, (7) backlog check, (8) manual release, and (9) legal update. The first six events are initiated by calling applications. When a quote or order entry is placed, a calling application supplies transaction data to the server 10. In response, the server 10 makes an export license determination and notifies the calling application of the license determination. If “hold” is the export license determination, details of the order are stored in the work buffer 24. If “okay” is the determination the details of the order are placed in the transaction data database 26.

Shortly before an order is shipped, a calling application requests the server 10 to perform a clearance check, to ensure that the order still complies with export regulations. The server 10, which already has the transaction data, returns a license determination. If “okay” is the determination, the shipment is allowed to proceed.

When the order is shipped, a calling application informs the server of this event, and the server 10 returns a status to the calling application. The server 10 also causes the details of the order to be moved from the transaction date database 26 to the audit trail database 32.

Usually an order is not shipped immediately after it is placed. Time will elapse. During that time, the order might be changed, or it might be cancelled. If the order is cancelled, a calling application informs the server 10 of this event. In response, the server 10 permanently removes the transaction details of the cancelled order from the work buffer 24 or the transaction data database 26. The server 10 also informs the calling application of the actions taken (status).

If the order is changed, a calling application informs the server 10 of this event. In response, the server 10 re-evaluates the order for compliance with export regulations. That is, an export license determination is performed on the changed order. The server 10 also informs the calling application of the actions taken.

The seventh event, the backlog check, is internal to the server 10. The server 10 may schedule the backlog check periodically (e.g., once a day). During a backlog check, export license determinations for all transactions in the work buffer 24 and the transaction data database 26 are performed. Instead of waiting for the backlog check to be performed at its scheduled time, the backlog may be checked immediately by initiating a manual release (the eighth event).

The eighth and ninth events (legal update) are initiated by a user such as an export administrator. If an export regulation is changed, the user causes the server 10 to perform an export license determination on each order in the work buffer 24 and the transaction data database 26. A legal update would occur, for example, if a country is moved to a list of embargoed countries. For any pending transactions concerning the newly embargoed country, transaction details would be moved from the transaction data database 26 to the work buffer 24.

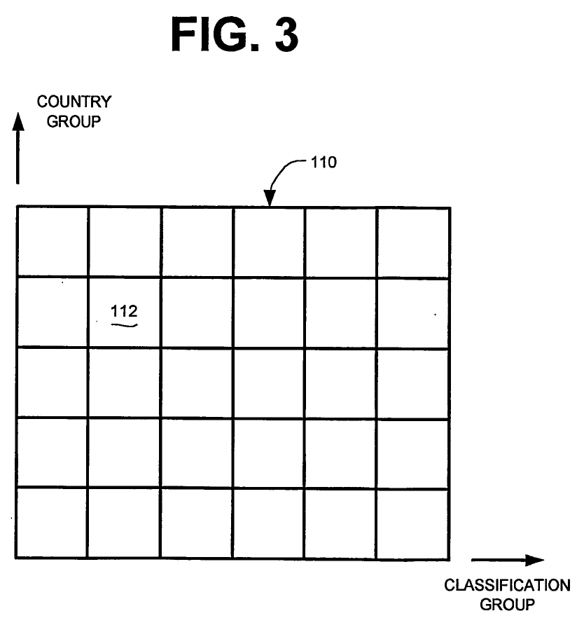

FIG. 3 shows one way in which the license determination table 18 may be organized: as a matrix 110. Country groups extend along one axis, and the classification groups extend along the other axis. Each cell 112 of the matrix 110 contains license information. Each row corresponds to a single country group and contains different license determinations for different classification groups. For example, one row might correspond to a group of embargoed countries. Each column corresponds to a single classification group and contains different license determinations for different country groups.

For example, one cell 112 might indicate that a license is not needed for the corresponding country group and classification. The license determination for that country group would be “NLR” (no license required).

Another cell 112 might indicate that a license is already in place for a given country group and classification group. The server 10 will then check the license portfolio table 20 to determine whether an actual license is available and its parameters match the given transactions. If the parameters match, the license determination for that country group and classification will be “okay.” If there is no match, the license determination for that country group and classification will be “hold” and the transaction will be placed in the work buffer 24 until further action is taken (e.g. applying for and adding the actual license into the license portfolio table 20).

Another cell 112 might indicate that a license is in place, but the product could be used for military as well as civilian purposes. The license determination for that country and product would be “hold,” and the transaction would be placed in the work buffer 24 until further action was taken (e.g., ensuring that the product would be used for civilian use only). It might also indicate the country in which the additional work is needed.

The matrix 110 shown in FIG. 3 contains thirty cells 112. In practice, any number of cells 112 may be used.

Although a specific embodiment of the present invention has been described and illustrated, the present invention is not limited to the specific forms or arrangements of parts so described and illustrated. Instead, the present invention is construed according to the claims that follow.

What is claimed is:

1. A system comprising a server for receiving license determination requests and providing export license determinations in response to the requests.

2. The system of claim 1, wherein the server includes a web-based interface for receiving the requests and providing the determinations.

3. The system of claim 1, further comprising at least one table; wherein the server provides an engine for using the table to make export license determinations.

4. The system of claim 3, wherein at least one table is a license determination table, the license determination table including cells organized according to country group and classification group, the engine using the license determination table to make the license determinations.

5. The system of claim 4, wherein the requests include destination country; wherein the server further provides a table for listing the country groups; and wherein the engine accesses the country group table to determine the group for a destination country.

6. The system of claim 4, wherein the request includes a product identification, and wherein the engine uses the identification to determine the classification group.

7. The system of claim 3, wherein at least one table is a license portfolio table for storing electronic versions of export licenses, the license portfolio table being accessible to the engine.

8. The system of claim 1, wherein the system is an enterprise system including the server.

9. The system of claim 1, wherein the license determination is event-driven.

10. The system of claim 1, further comprising a transaction data database for maintaining details of pending transactions.

11. The system of claim 1, further comprising an audit trail database for storing details of transaction that have been shipped.

12. The system of claim 1, further comprising a work buffer for maintaining details of pending transactions that need further attention.

13. The system of claim 1, wherein the server re-evaluates license determinations in response to certain events.

14. The system of claim 13, wherein the server re-evaluates a pending transaction that has been changed.

15. The system of claim 13, wherein the server re-evaluates all pending transactions in response to a legal event.

16. The system of claim 13, wherein the server performs clearance checks.

17. A server comprising an interface for receiving license determination requests; and a table-driven engine for providing export license determinations in response to the requests.

18. The server of claim 17, wherein the engine accesses a license determination table to make the license determinations.

19. The server of claim 17, wherein the engine stores details of pending transactions in a transaction data database.

20. The server of claim 17, wherein the engine stores details of pending transactions that need further attention in a work buffer.

21. The server of claim 17, wherein license determinations are re-evaluated in response to certain events.
